(19) United States
(12) Patent Application Publication
(10) Pub. No.: US 2020/0301815 A1
(43) Pub. Date: Sep. 24, 2020

(54) USING SYNTHETIC INPUTS TO COMPARE EXECUTION OF DIFFERENT CODE VERSIONS

(71) Applicant: Microsoft Technology Licensing, LLC, Redmond, WA (US)

(72) Inventor: Jordi MOLA, Bellevue, WA (US)

(21) Appl. No.: 16/541,647

(22) Filed: Aug. 15, 2019

Related U.S. Application Data
(63) Continuation-in-part of application No. 16/358,194, filed on Mar. 19, 2019.

(51) Int. Cl. G06F 11/36; G06F 8/71

(52) U.S. Cl. CPC G06F 11/3612; G06F 2201/865; G06F 8/71; G06F 11/3636

(57) ABSTRACT

Using synthetic inputs to determine if different versions of executable code execute equivalently. First and second versions of code are accessed. Based on recorded execution(s), a first code path is identified in the first code version that lacks execution coverage. A second code path is identified in the second code version that maps to the first code path. Synthetic inputs are generated for the first code path. The first and second code paths are emulated using the generated synthetic inputs, resulting in first outputs for the first code path and second outputs for the second code path. It is determined if there are any differences between the first and second outputs. If so, it is reported that the first and second code paths do not execute equivalently when supplied with the synthetic inputs. Otherwise, it is reported that the first and second code paths execute equivalently.

### CROSS-REFERENCE TO RELATED APPLICATIONS

This application is a continuation-in-part of U.S. Ser. No. 16/358,194, filed Mar. 19, 2019, and entitled, “USING SYNTHETIC INPUTS DURING EMULATION OF AN EXECUTABLE ENTITY FROM A RECORDED EXECUTION,” the entire contents of which are incorporated by reference herein in their entirety.

### BACKGROUND

Tracking down and correcting undesired software behaviors is a core activity in software development. Undesired software behaviors can include many things, such as execution crashes, runtime exceptions, slow execution performance, incorrect data results, data corruption, and the like. Undesired software behaviors might be triggered by a vast variety of factors such as data inputs, user inputs, race conditions (e.g., when accessing shared resources), etc. Given the variety of triggers, undesired software behaviors can be rare and seemingly random, and extremely difficult reproduce. As such, it can be very time-consuming and difficult for a developer to identify a given undesired software behavior. Once an undesired software behavior has been identified, it can again be time-consuming and difficult to determine its root cause(s).

Developers have conventionally used a variety of approaches to identify undesired software behaviors, and to then identify the location(s) in an application's code that cause the undesired software behavior. For example, a developer might test different portions of an application's code against different inputs (e.g., unit testing). As another example, a developer might reason about execution of an application's code in a debugger (e.g., by setting breakpoints/watchpoints, by stepping through lines of code, etc. as the code executes). As another example, a developer might observe code execution behaviors (e.g., timing, coverage) in a profiler. As another example, a developer might insert diagnostic code (e.g., trace statements) into the application's code.

While conventional diagnostic tools (e.g., debuggers, profilers, etc.) have operated on “live” forward-executing code, an emerging form of diagnostic tools enable “historic” debugging (also referred to as “time travel” or “reverse” debugging), in which the execution of at least a portion of a program's thread(s) is recorded into one or more trace files (i.e., a recorded execution). Using some tracing techniques, a recorded execution can contain “bit-accurate” historic trace data, which enables the recorded portion(s) the traced thread(s) to be virtually “replayed” down to the granularity of individual instructions (e.g., machine code instructions, intermediate language code instructions, etc.). Thus, using “bit-accurate” trace data, diagnostic tools can enable developers to reason about a recorded prior execution of subject code, as opposed to a “live” forward execution of that code. For example, a historic debugger might enable both forward and reverse breakpoints/watchpoints, might enable code to be stepped through both forwards and backwards, etc. A historic profiler, on the other hand, might be able to derive code execution behaviors (e.g., timing, coverage) from prior-executed code.

### BRIEF SUMMARY

At least some embodiments described herein leverage historic debugging technologies to generate and use synthetic input values during emulation of execution of an executable entity from a recorded execution. In particular, during emulation of execution of an executable entity based on one or more recorded executions, embodiments can identify one or more portions of code of the executable entity for which no recorded execution exists. Embodiments can then generate one or more synthetic inputs to cause execution of those portion(s) of code to be emulated. Embodiments may also record the emulated execution of these code portion(s). As such, embodiments can operate to synthetically cause an emulated code execution coverage that goes beyond what was recorded into the recorded execution(s), and record that synthetically-caused emulated code execution into one or more additional recorded execution(s).

At least some embodiments herein also use synthetic inputs to compare execution of different code versions. In embodiments, this includes using synthetic inputs to determine if different versions of executable code execute equivalently. For example, embodiments may access first and second versions of code, along with one or more recorded executions of either (or both) of these code versions. Embodiments can identify a first code path in the first code version that lacks trace execution coverage in the recorded execution(s), and generate synthetic inputs for exercising this first code path. Embodiments can also identify a corresponding second code path in the second code version. Embodiments can then use the generated synthetic inputs to emulate both the first and second code paths, and compare the outputs generated this emulation to determine if the first and second code paths executed equivalently. This process can operate either way; thus, it could also use synthetic inputs generated to exercise a code path in the second code version to emulate a code path in the first code version. Accordingly, these embodiments can verify whether the code versions executed equivalently, while also increasing code execution coverage of both code versions.

In some embodiments methods, systems, and computer program products use synthetic inputs during an emulated execution from a recorded execution to reach a code path not recorded in the recorded execution. In these embodiments, one or more recorded executions of an executable entity are accessed. The one or more recorded executions include recorded inputs that were consumed during one or more prior executions of the executable entity. Based on the one or more recorded executions, one or more code paths for which there is no recorded execution coverage in the one or more recorded executions are identified. Execution of the identified one or more code paths is emulated using one or more synthetic inputs. The emulated execution comprises emulating execution of one or more first executable instructions using the recorded inputs to reach an execution point preceding the one or more code paths; generating the one or more synthetic inputs, which would cause one or more second executable instructions of the one or more code paths to be executed; and, based on use of the one or more synthetic inputs, emulating execution of the one or more second executable instructions.

In other embodiments methods, systems, and computer program products use synthetic inputs to determine if different versions of executable code execute equivalently. In these embodiments, first and second versions of executable code are accessed. In addition, one or more recorded executions recording one or more prior executions of one or both of the first version of the executable code or the second version of the executable code are accessed. Based on the one or more recorded executions, a first code path in the first version of the executable code is identified, for which there is no recorded execution coverage in the one or more recorded executions. A second code path in the second version of the executable code that maps to the identified first code path in the first version of the executable code is also identified. One or more synthetic inputs are generated for exercising the first code path. The one or more synthetic inputs are selected to cause executable instructions of the first code path to be executed. Execution of the first code path is emulated, based on supplying the first code path with the one or more synthetic inputs. One or more first outputs of the emulation of the first code path are identified. Execution of the second code path is also emulated, based on supplying the second code path with the one or more synthetic inputs. One or more second outputs of the emulation of the second code path are identified. It is determined whether there are any differences between the first and second outputs. When there are no differences between the first and second outputs, it is reported that the first and second code paths execute equivalently when supplied with the one or more synthetic inputs. When there are one or more differences between the first and second outputs, it is reported that the first and second code paths do not execute equivalently when supplied with the one or more synthetic inputs.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computing environment that facilitates use of synthetic input values during emulation of execution of an executable entity from a recorded execution, including using synthetic inputs to compare execution of different code versions;

FIG. 1B illustrates an example debugging component;

FIG. 2 illustrates an example computing environment in which the computer system of FIG. 1A is connected to one or more other computer systems over one or more networks;

FIG. 3 illustrates an example of a recorded execution of an executable entity;

FIG. 4 illustrates an example of mappings between corresponding functions in the code of two executable entities, in which the functions are identified based on their inputs and outputs;

FIG. 5A illustrates an example that includes a code snippet showing a series of three control statements;

FIG. 5B illustrates an example that shows possible code execution paths of the control statements in the code snippet of FIG. 5A;

FIG. 5C illustrates an example that shows possible code execution paths of the second and third control statements in the code snippet of FIG. 5A;

FIG. 6 illustrates an example of substituting synthetic inputs while emulating an executable entity from a recorded prior execution of the entity;

FIG. 7 illustrates a flowchart of an example method for using synthetic inputs during an emulated execution from a recorded execution to reach a code path not recorded in the recorded execution;

FIG. 8A illustrates an example of using synthetic inputs generated for exercising a code path in one version of an application in order to emulate execution of another version of the application;

FIG. 8B further illustrates an example of using synthetic inputs generated for exercising a code path in one version of an application in order to emulate execution of another version of the application; and

FIG. 9 illustrates a flowchart of an example method for using synthetic inputs to determine if different versions of executable code execute equivalently.

### DETAILED DESCRIPTION

At least some embodiments described herein leverage historic debugging technologies to generate and use synthetic input values during emulation of execution of an executable entity from a recorded execution. In particular, during emulation of execution of an executable entity based on one or more recorded executions, embodiments can identify one or more portions of code of the executable entity for which no recorded execution exists. Embodiments can then generate one or more synthetic inputs to cause execution of those portion(s) of code to be emulated. Embodiments may also record the emulated execution of these code portion(s). As such, embodiments can operate to synthetically cause an emulated code execution coverage that goes beyond what was recorded into the recorded execution(s), and record that synthetically-caused emulated code execution into one or more additional recorded execution(s).

Synthetically generated inputs might be used to exercise first code whose execution has been recorded into the recorded execution(s), and/or to exercise second code whose execution is not recorded into the recorded execution(s). The first and second code might have differences, but might be functionally related; for example, they may be compiled from the same source code using different compilers and/or different compiler settings, or may be compiled from different versions of the same source code project. If operating on the first code, embodiments can use synthetically generated inputs to exercise the first code beyond what was originally traced into the recorded execution(s). If operating on the second code, embodiments can leverage recorded inputs from prior execution(s) of the first code, plus synthetically generated inputs, to exercise the second code.

At least some embodiments herein also use synthetic inputs to compare execution of different code versions. In embodiments, this includes using synthetic inputs to determine if different versions of executable code execute equivalently. For example, embodiments may access first and second versions of code, along with one or more recorded executions of either (or both) of these code versions. Embodiments can identify a first code path in the first code version that lacks trace execution coverage in the recorded execution(s), and generate synthetic inputs for exercising this first code path. Embodiments can also identify a corresponding second code path in the second code version. Embodiments can then use the generated synthetic inputs to emulate both the first and second code paths, and compare the outputs generated this emulation to determine if the first and second code paths executed equivalently. This process can operate either way; thus, it could also use synthetic inputs generated to exercise a code path in the second code version to emulate a code path in the first code version. Accordingly, these embodiments can verify whether the code versions executed equivalently, while also increasing code execution coverage of both code versions.

As indicated, the embodiments herein operate on recorded executions of executable entities. In this description, and in the following claims, a “recorded execution,” can refer to any data that stores a record of a prior execution of code instruction(s), or that can be used to at least partially reconstruct the prior execution of the prior-executed code instruction(s). In general, these code instructions are part of an executable entity, and execute on physical or virtual processor(s) as threads and/or processes (e.g., as machine code instructions), or execute in a managed runtime (e.g., as intermediate language code instructions).

A recorded execution used by the embodiments herein might be generated by a variety of historic debugging technologies. In general, historic debugging technologies record or reconstruct the execution state of an entity at various times, in order to enable execution of that entity to be at least partially emulated later from that execution state. The fidelity of that virtual execution varies depending on what recorded execution state is available.

For example, one class of historic debugging technologies, referred to herein as time-travel debugging, continuously records a bit-accurate trace of an entity's execution. This bit-accurate trace can then be used later to faithfully replay that entity's prior execution down to the fidelity of individual code instructions. For example, a bit-accurate trace might record information sufficient to reproduce initial processor state for at least one point in a thread's prior execution (e.g., by recording a snapshot of processor registers), along with the data values that were read by the thread's instructions as they executed after that point in time (e.g., the memory reads). This bit-accurate trace can then be used to replay execution of the thread's code instructions (starting with the initial processor state) based on supplying the instructions with the recorded reads.

Another class of historic debugging technology, referred to herein as branch trace debugging, relies on reconstructing at least part of an entity's execution state based on working backwards from a dump or snapshot (e.g., a crash dump of a thread) that includes a processor branch trace (i.e., which includes a record of whether or not branches were taken). These technologies start with values (e.g., memory and register) from this dump or snapshot and, using the branch trace to at least partially determine code execution flow, iteratively replay the entity's code instructions and backwards and forwards in order to reconstruct intermediary data values (e.g., register and memory) used by this code until those values reach a steady state. These techniques may be limited in how far back they can reconstruct data values, and how many data values can be reconstructed. Nonetheless, the reconstructed historical execution data can be used for historic debugging.

Yet another class of historic debugging technology, referred to herein as replay and snapshot debugging, periodically records full snapshots of an entity's memory space and processor registers while it executes. If the entity relies on data from sources other than the entity's own memory, or from a non-deterministic source, these technologies might also record such data along with the snapshots. These technologies then use the data in the snapshots to replay the execution of the entity's code between snapshots.

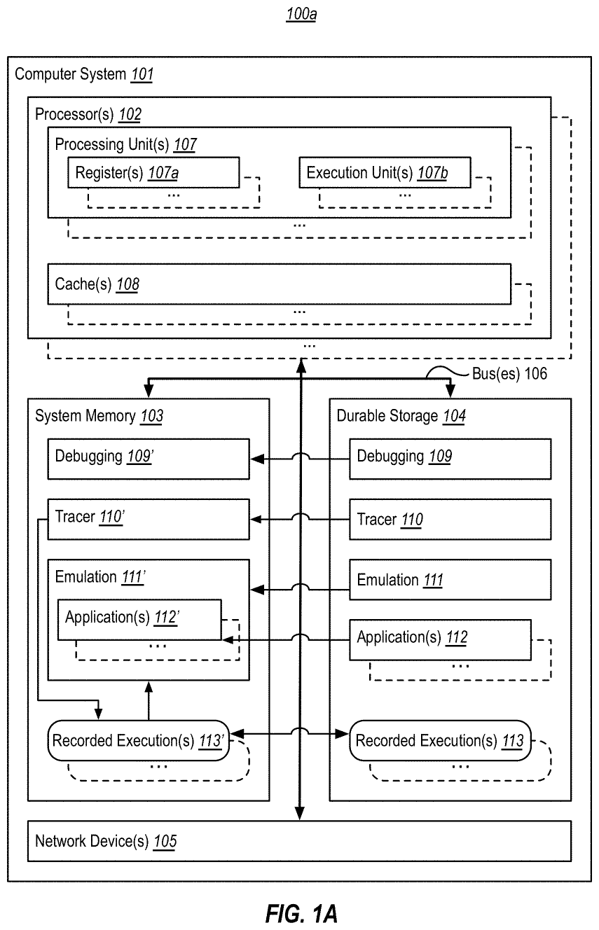

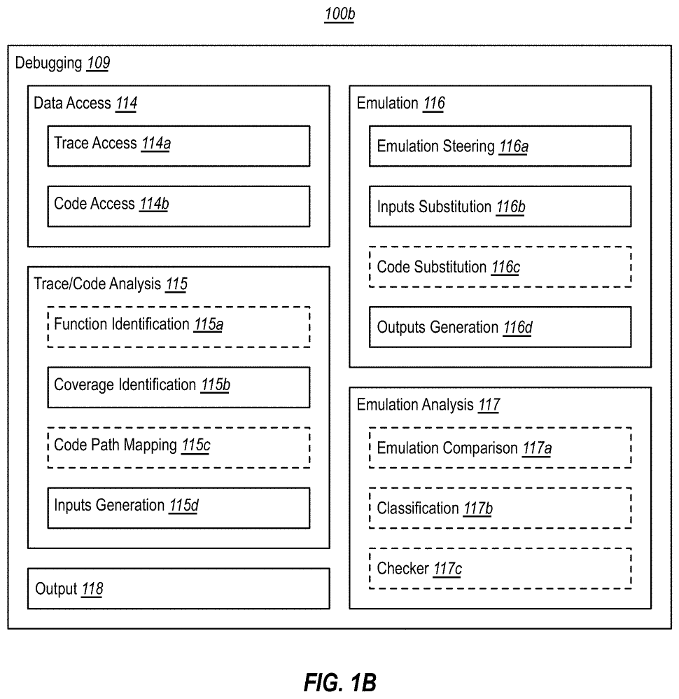

FIG. 1A illustrates an example computing environment 100a that facilitates use of synthetic input values during emulation of execution of an executable entity from a recorded execution, including using synthetic inputs to compare execution of different code versions. As depicted, computing environment 100a may comprise or utilize a special-purpose or general-purpose computer system 101, which includes computer hardware, such as, for example, one or more processors 102, system memory 103, durable storage 104, and/or network device(s) 105, which are communicatively coupled using one or more communications buses 106.

Embodiments within the scope of the present invention can include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media (e.g., system memory 103 and/or durable storage 104) that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network device(s) 105), and then eventually transferred to computer system RAM (e.g., system memory 103) and/or to less volatile computer storage media (e.g., durable storage 104) at the computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, machine code instructions (e.g., binaries), intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

As shown in FIG. 1A, each processor 102 can include (among other things) one or more processing units 107 (e.g., processor cores) and one or more caches 108. Each processing unit 107 loads and executes machine code instructions via the caches 108. During execution of these machine code instructions at one more execution units 107b, the instructions can use internal processor registers 107a as temporary storage locations and can read and write to various locations in system memory 103 via the caches 108. In general, the caches 108 temporarily cache portions of system memory 103; for example, caches 108 might include a “code” portion that caches portions of system memory 103 storing application code, and a “data” portion that caches portions of system memory 103 storing application runtime data. If a processing unit 107 requires data (e.g., code or application runtime data) not already stored in the caches 108, then the processing unit 107 can initiate a “cache miss,” causing the needed data to be fetched from system memory 103—while potentially “evicting” some other data from the caches 108 back to system memory 103.

As illustrated, the durable storage 104 can store computer-executable instructions and/or data structures representing executable software components; correspondingly, during execution of this software at the processor(s) 102, one or more portions of these computer-executable instructions and/or data structures can be loaded into system memory 103. For example, the durable storage 104 is shown as storing computer-executable instructions and/or data structures corresponding to a debugging component 109, a tracer component 110, an emulation component 111, and one or more application(s) 112. The durable storage 104 can also store data, such as one or more recorded execution(s) 113 (e.g., generated using one or more of the historic debugging technologies described above).

In general, the debugging component 109 leverages the emulation component 111 in order to emulate execution of code of executable entities, such as one or more of applications 112, based on execution state data obtained from one or more of the recorded execution(s) 113. Thus, FIG. 1A shows that the debugging component 109 and the emulation component 111 are loaded into system memory 103 (i.e., debugging component 109′ and emulation component 111′), and that one or more of applications 112 is/are being emulated within the emulation component 111′ (i.e., application(s) 112′).

In general, the tracer component 110 records or “traces” execution of one or more of applications 112 into the recorded execution(s) 113 (e.g., using one or more types of the historic debugging technologies described above). The tracer component 110 can record execution of an application 112 whether that execution be a “live” execution on the processor(s) 102 directly, whether that execution be a “live” execution on the processor(s) 102 via a managed runtime, and/or whether that execution be an emulated execution via the emulation component 111. Thus, FIG. 1A also shows that the tracer component 110 is also loaded into system memory 103 (i.e., tracer component 110′). An arrow between tracer component 110′ and recorded execution(s) 113′ indicates that the tracer component 110′ can record trace data into recorded execution(s) 113′ (which might then be persisted to the durable storage 104 as recorded execution(s) 113).

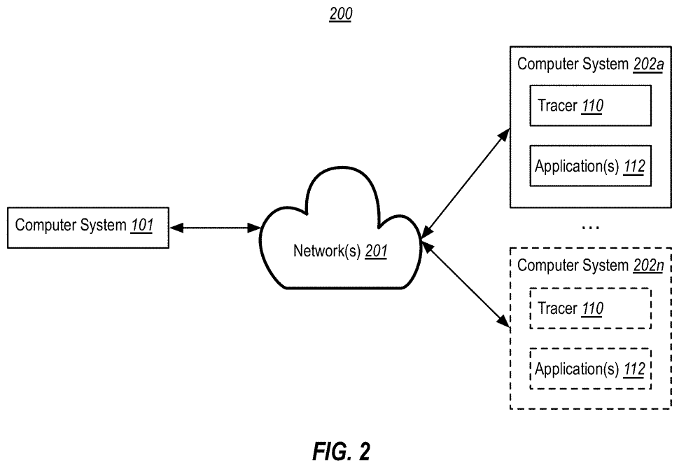

Computer system 101 might additionally, or alternatively, receive one or more of the recorded execution(s) 113 from another computer system (e.g., using network device(s) 105). For example, FIG. 2 illustrates an example computing environment 200 in which computer system 101 of FIG. 1A is connected to one or more other computer systems 202 (i.e., computer systems 202a-202n) over one or more networks 201. As shown in example 200, each computer system 202 includes a tracer component 110 and or more of application(s) 112. As such, computer system 101 may receive, over the network(s) 201, one or more recorded execution(s) 113 of prior execution(s) of one or more of application(s) 112 at these computer system(s) 202.

Returning to FIG. 1A, when there are multiple applications 112, two or more of these applications might be different, but functionally related. For example, two or more of applications 112 might be functionally related because they were compiled from identical source code, but with different compiler settings. For instance, one of applications 112 might be a build that has one or more compiler optimization flags enabled (e.g., a “production build”), while another of applications 112 might be a build that has these compiler optimization flag(s) disabled (e.g., a “debug” build). Additionally, or alternatively, one of applications 112 might be compiled with one version of a compiler, while another of applications 112 is compiled with another version of the compiler. Additionally, or alternatively, two or more of applications 112 might compiled with different compiler products altogether. As another example, two or more of applications 112 might be functionally related because they were compiled from different versions of the same source code. For instance, one of applications 112 might be built from one version of source code, while another of applications 112 is built from a more recent version of the source code that includes fixes, such as bug fixes and/or performance improvements. When referring to different “versions” of an application 112 or executable code herein, one or more of the foregoing scenarios might be the reason that one “version” of code differs from another.

It is noted that, while the debugging component 109, the tracer component 110, and/or the emulation component 111 might each be independent components or applications, they might alternatively be integrated into the same application (such as a debugging suite), or might be integrated into another software component-such as an operating system component, a hypervisor, a cloud fabric, etc. As such, those skilled in the art will also appreciate that the invention may be practiced in a cloud computing environment of which computer system 101 is a part.

It was mentioned previously that the debugging component 109 leverages the emulation component 111 in order to emulate execution of code of one or more of applications 112 using execution state data from one or more of the recorded execution(s) 113. In accordance with embodiments herein, when emulating execution of a given application 112, the debugging component 109 is able to identify one or more code paths in the application 112 for which there is no code execution coverage in the trace data of the recorded execution(s) 113. Stated differently, the debugging component 109 can detect situations in which none of the recorded execution(s) 113 include data recording execution of one or more executable instructions of the application 112, and/or in which none of the recorded execution(s) 113 include data recording particular combinations of a plurality of executable instructions of the application 112. In these situations, the debugging component 109 can generate synthetic inputs in order to cause the emulation component 111 to exercise these code paths. In embodiments, the debugging component 109 can also leverage the tracer component 110 to record the emulated execution of these code paths into the recorded executions 113 (e.g., by adding to an existing recorded execution 113, and/or creating a new recorded execution 113).

As will be appreciated in view of the disclosure herein, identifying and exercising previously untraced code during emulation of an application 112 whose execution has been traced into recorded executions 113 can be useful for many debugging purposes. For example, the debugging component 109 might use synthetic inputs to exercise code paths in an application 112 that were never exercised in the recorded execution(s) 113. As such, the debugging component 109 can exercise code paths of an application that may be rare or difficult to exercise during normal operation of the application 112.

Additionally, it was also mentioned that applications 112 might include applications that are different, but functionally related. In accordance with some embodiments herein, the debugging component 109 can use execution state data in the recorded execution(s) 113 relating to a prior execution of a first application in applications 112 in order to guide emulation of executable code corresponding to a second, related, application in applications 112—even though the recorded execution(s) 113 might lack information regarding execution of the second application. Thus, the debugging component 109 can effectively use the emulation component 111 to guide emulation of non-traced code (e.g., the second application) based on a recorded execution of related traced code (e.g., the first application).

As will be appreciated in view of the disclosure herein, emulating non-traced code with recorded execution(s) of related traced code can also be useful for many debugging purposes. For example, it can be used to detect/identify bugs or differences in compilers. For instance, if a traced application and a non-traced application were both compiled from the same source code, but with different compiler products, different compiler settings, and/or different compiler versions, these applications should both exhibit equivalent behaviors during their execution. However, if emulation of the non-traced application based a recorded execution of the traced application produces different results than the traced application produced during its recorded execution, there is evidence of compiler bugs (or, at least, functional differences between compiler products or versions).

In another example, emulating non-traced code with a recorded execution of related traced code can be useful to test source code changes that were intended to make only performance improvements. For instance, if a traced application is compiled from a version of source code that includes only performance improvements as compared to a version of source code from which a non-traced application was compiled, then the non-traced application should exhibit equivalent behaviors as the trace application when it is being emulated using trace data gathered during execution of the traced application; if there is a difference, then the performance improvements caused behavioral changes that may have introduced bug(s)/regression(s).

In another example, emulating non-traced code with recorded execution(s) of related traced code can be useful to test source code changes that were intended to make only bug fixes. For instance, suppose that recorded executions 113 include ten recorded executions of a first application, two of which exhibit some undesired behavior (e.g., bug). If a second application was compiled from a version of source code that includes a fix for this bug, then the second application should not exhibit the undesired behavior when being emulated using the two recorded executions during which the first application exhibited the undesired behavior; otherwise, the bug was probably not fixed. Additionally, the second application should exhibit equivalent behaviors as the first application when it is being emulated using the other eight recorded executions; otherwise, the bug fix probably introduced new bug(s)/regression(s).

In another example, emulating non-traced code with recorded execution(s) of related traced code can be used to debug non-optimized code, based on trace data that was captured during execution of optimized code. As will be appreciated by those of skill in that art, it can be difficult for a human user to reason about execution of code that was compiled with compiler optimizations enabled. For instance, when visualizing execution of optimized code in a debugger, the executed code flow may not appear to correspond to the expected code flow of the source code that the human user interacts with. Thus, for example, a first application may be a compiler-optimized “production” build that is in active use, with its execution being traced into the recorded execution(s) 113. Because this first application comprises optimized code, it may be difficult for a human user to reason about the execution behaviors that are traced into recorded execution(s) 113 (e.g., if the debugging component 109 caused this application to be emulated using the recorded execution 113). However, embodiments might use trace data in this recorded execution 113 to emulate execution of a second application, which might be a “debug” build that was compiled without optimizations settings enabled-making it much easier for a human user to reason about the execution behaviors that are traced into the recorded execution 113.

In embodiments, the debugging component 109 might combine the generation and use of synthetic inputs during code emulation with the emulation of non-traced code using recorded execution(s) of related traced code. For example, suppose that an executable entity that is the subject of analysis by the debugging component 109 is a second version of an application, and that the recorded execution(s) 113 record prior execution(s) of a different executable entity that was a first version of the application. For instance, the second version of the application might include bug fixes and/or performance enhancements over the traced first version of the application. In this situation, the debugging component 109 might emulate execution of this newer second version of the application based on the recorded execution(s) 113 of the first version of the application, while at the same time generating and using synthetic inputs to exercise non-traced code in the second version. This non-traced code might correspond, for example, to new/changed code resulting from those bug fixes and/or performance enhancements. Thus, the debugging component 109 can use synthetic inputs to exercise and test this new/changed code prior to deployment of the second version of the application.

In embodiments, the debugging component 109 might utilize synthetic inputs to compare execution of different code versions, such as to compare execution of (at least a portion of) a first version of application 112 with execution of (at least a portion of) a second version of application 112. This can include using synthetic inputs to more fully exercise execution of one, or both, application versions, and to determine if these different application versions execute equivalently. For example, in embodiments, the debugging component 109 accesses first and second versions of an application 112, along with one or more recorded executions 113. These recorded execution(s) 113 could include recorded executions of either, or both, versions of the application 112. The debugging component 109 identifies a first code path in one version of the application that lacks trace execution coverage in these recorded execution(s) 113, and generates synthetic inputs for exercising this first code path. The debugging component identifies a corresponding second code path in the other version of the application (the execution of which may, or may not be traced in the recorded executions 113), and uses the generated synthetic inputs to emulate both the first and second code paths. Emulation of the first and second code paths generates a set of outputs for each code path. Thus, the debugging component 109 can compare these outputs to determine if the first and second code paths executed equivalently (at least when supplied with the synthetic inputs), and can report accordingly.

The foregoing embodiment of using synthetic inputs that were generated to exercise one version of code in order to emulate execution of another version of code can operate in either, or both, directions. For example, in addition (or as an alternative) to using synthetic inputs that were generated for exercising a first code path of a first application version in order to emulate a second code path of a second application version, the debugging component 109 might identify a third code path in the second application version, generate synthetic inputs for exercising this third code path, and use these synthetic inputs to emulate a fourth code path in the first application version. In addition, by identifying and emulating code paths that lacked execution coverage in one, or both, application versions, the debugging component 109 can increase overall execution coverage of one, or both, application versions (e.g., by tracing the emulated code path(s) into the recorded execution(s) 113).

To demonstrate how the debugging component 109 might accomplish one or more of (i) the generation and use of synthetic inputs during code emulation, (ii) the emulation of non-traced code with a recorded execution of related traced code, or (iii) using synthetic inputs to compare different versions of an application 112, FIG. 18 illustrates an example 100b that provides additional detail of the debugging component 109 of FIG. 1A. The depicted debugging component 109 in FIG. 18 includes a variety of components (e.g., data access 114, trace/code analysis 115, emulation 116, emulation analysis 117, output 118, etc.) that represent various functions that the debugging component 109 might implement in accordance with various embodiments described herein. It will be appreciated that the depicted components—including their identity, sub-components, and arrangement—are presented merely as an aid in describing various embodiments of the debugging component 109 described herein, and that these components are non-limiting to how software and/or hardware might implement various embodiments of the debugging component 109 described herein, or of the particular functionality thereof.

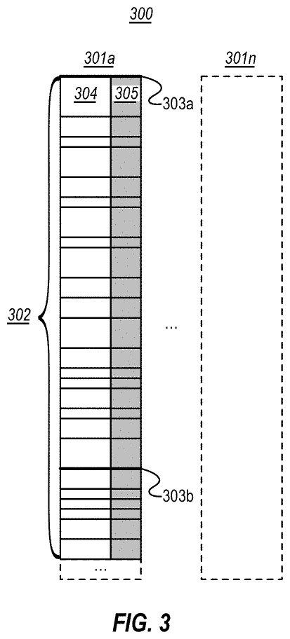

The data access component 114 includes a trace access component 114a and a code access component 114b. The trace access component 114a accesses one or more of the recorded execution(s) 113, such as one or more recorded executions 113 of one or more prior executions of one or more of applications 112. This might include accessing one or more recorded executions 113 of one or more prior executions of different versions of a given application 112. FIG. 3 illustrates one example of a recorded execution 300 of an executable entity (e.g., application 112) that might be accessed by the trace access component 114a, where the recorded execution 300 might have been generated using time-travel debugging technologies.

In the example of FIG. 3, recorded execution 300 includes a plurality of data streams 301 (i.e., data streams 301a-301n). In embodiments, each data stream 301 records execution of a different thread that executed from the code of an application 112. For example, data stream 301a might record execution of a first thread of an application 112, while data stream 301n records an nth thread of that application 112. As shown, data stream 301a comprises a plurality of data packets 302. Since the particular data logged in each data packet 302 might vary, they are shown as having varying sizes. In general, when using time-travel debugging technologies, one or more of data packets 302 record at least the inputs (e.g., register values, memory values, etc.) to one or more executable instructions that executed as part of this first thread of the application 112. As shown, data stream 301a might also include one or more key frames 303 (e.g., key frames 303a and 303b) that each records sufficient information, such as a snapshot of register and/or memory values, that enables the prior execution of the thread to be replayed by the emulation component 116—starting at the point of the key frame forwards.

In embodiments, a recorded execution 113 might also include the actual code that was executed as part of an application 112. Thus, in FIG. 3, each data packet 302 is shown as including a non-shaded data inputs portion 304 and a shaded code portion 305. In embodiments, the code portion 305 of each data packet 302 might include the executable instructions that executed based on the corresponding data inputs. In other embodiments, however, a recorded execution 113 might omit the actual code that was executed, instead relying on having separate access to the code of the application 112 (e.g., from durable storage 104). In these other embodiments, each data packet may, for example, specify an address or offset to the appropriate executable instruction(s). Although not shown, it may also be possible that the recorded execution 300 includes a data stream 301 that stores the outputs of code execution.

If there are multiple data streams 301, each recording execution of a different thread, these data streams might include sequencing events. Each sequencing event records the occurrence of an event that is orderable across the threads. For example, sequencing events might correspond to interactions between the threads, such as accesses to memory that is shared by the threads. Thus, for instance, if a first thread that is traced into a first data stream (e.g., 301a) writes to a synchronization variable, a first sequencing event might be recorded into that data stream (e.g., 301a). Later, if a second thread that is traced into a second data stream (e.g., 301b) reads from that synchronization variable, a second sequencing event might be recorded into that data stream (e.g., 301b). These sequencing events might be inherently ordered. For example, each sequencing event might be associated with a monotonically incrementing value, with the monotonically incrementing values defining a total order among the sequencing events. For instance, a first sequencing event recorded into a first data stream might be given a value of one, a second sequencing event recorded into a second data stream might be given a value of two, etc.

Returning to FIG. 1B, the code access component 114b might obtain the code of one or more of applications 112. If the recorded execution(s) 114 obtained by the trace access component 114a included the traced code (e.g., code portion 305), then the code access component 114b might extract that code from the recorded execution(s) 113. Alternatively, the code access component 114b might obtain the code of one or more of applications 112 from the durable storage 104. In embodiments, the code access component 114b might access multiple versions of this code, such as different builds of the same application 112 (e.g., from different source code versions, with different compiler products or versions, with different compiler settings, etc.).

The trace/code analysis component 115 can perform one or more types of analysis on the recorded execution(s) 113 and/or the applications 112 that were accessed by the data access component 114. For instance, the trace/code analysis component 115 is shown as potentially including one or more of a function identification component 115a, a coverage identification component 115b, a code path mapping component 115c, and an inputs generation component 115d.

If present, the function identification component 115a can identify mappings between different code sections in different executable entities (i.e., two or more of applications 112, such as different versions of a given application), which mappings are usable to emulate the code of one of the entities using the execution state data recorded in recorded executions 113 during execution of the other entity (e.g., the data inputs portions 304 of data packets 302). In embodiments, the function identification component 115a identifies mappings between corresponding “functions” in the code of these applications, based on identifying inputs and outputs to those functions.

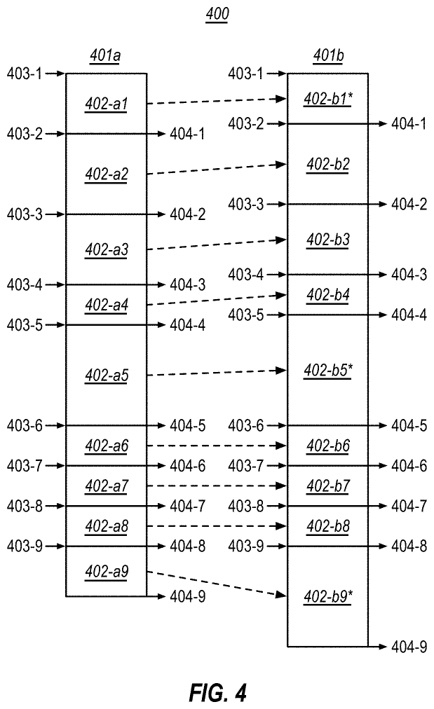

For example, FIG. 4 illustrates an example 400 of mappings between corresponding “functions” in the code of two different (but related) executable entities, in which the functions are identified based on their inputs and outputs. In particular, FIG. 4 shows a representation 401a of code of a first application of applications 112, as well as a representation 401b of code of a second application of applications 112. FIG. 4 also shows that there is correspondence between different chunks of code (functions) in the two representations 401. For example, function 402-a1 in representation 401a corresponds to function 402-b1 in representation 401b, function 402-a2 in representation 401a corresponds to function 402-b2 in representation 401b, and so on. Notably, while, for clarity, there is a linear correspondence between identified functions, this need not be the case. For instance, in an alternative mapping it might be that function 402-a9 corresponds to function 402-b1 and that function 402-a1 corresponds to function 402-b9, such that an arrow between functions 402-a9 and 402-b1 would cross an arrow between functions 402-a1 and 402-b9.

As used herein, a “function” is defined as a collection of one or more sections of execution, each section comprising a sequence of one or more executable instructions that has zero or more “inputs” and one or more “outputs.” A function in the code of one application can map to a corresponding function in the code of another application if these functions both read from the same input(s) (if any) and write to the same output(s), even if the code in those functions is not identical. For example, in FIG. 4, each function 402 has a corresponding set of input(s) 403 and a corresponding set of output(s) 404. Function 402-a1 in representation 401a, for instance, has a set of input(s) 403-1 and a set of outputs 404-1, function 402-a2 in representation 401a has a set of input(s) 403-2 (which could, for example, be the output(s) 404-1 of function 402-a1) and a set of outputs 404-2, etc. As shown, corresponding functions between representations 401a and 401b have the same sets of inputs and outputs. For example, function 402-b1 in representation 401b has the same sets of inputs and outputs (i.e., inputs 403-1 and outputs 404-1) as function 402-a1 in representation 401a, function 402-b2 in representation 401b has the same sets of inputs and outputs (i.e., inputs 403-2 and outputs 404-2) as function 402-a2 in representation 401a, etc. Generally, the function identification sub-component 115a attempts to map functions that are closely related in behavior.

As used herein, an “input” is defined as any data location from which a function (as defined above) reads, and to which the function itself has not written prior to the read. These data locations could include, for example, registers as they existed the time the function was entered, and/or any memory location from which the function reads and which it did not itself allocate. An edge case may arise if a function allocates memory and then reads from that memory prior to initializing it. In these instances, embodiments might either treat the read to uninitialized memory as an input, or as a bug. As used herein, an “output” is defined as any data location (e.g., register and/or memory location) to which the function writes that it does not later deallocate. For example, a stack allocation at function entry, followed by a write to the allocated area, followed by a stack deallocation at function exit, would not be considered a function output. In addition, if a function is delimited by application binary interface (ABI) boundaries, then any volatile registers (i.e., registers not used to pass a return value) at function exit are implicitly “deallocated” (i.e., they are discarded by the ABI)—and are thus not outputs for the function.

In embodiments, the function identification component 115a might rely a known ABI of the operating system and processor instruction set architecture (ISA) for which an application is compiled in order to know which register(s) are input(s) to a function and/or which register(s) are output(s) from a function—reducing the need to track registers individually. Thus, for instance, instead of tracking registers individually, the function identification component 115a might use an ABI for which an application was compiled to determine which register(s) application 112 uses to pass parameters to functions, and/or which register(s) application 112 uses for return values. In embodiments, debugging symbols might be used to complement, or replace ABI information. Notably, even if calling function ignores the return value of a called function, an ABI and/or symbols may still be usable to determine if the contents of a register used to store the called function's return value have changed.

As mentioned, a given function might be a collection of one or more sections of one or more executable instructions. At times, it might take a plurality of sections in order to identify functions that cleanly map from one application to another. For example, it may be that a particular section might be identifiable in one application that does not cleanly map to the other application. As such, this section, itself, would be a poor choice for a “function” that maps between applications (i.e., having the same inputs and outputs, and doing equivalent work). Even if compiled from identical source code, such differences could arise due to compiler optimization settings, in which code in one application is transformed by a compiler in a way that does not directly map to another application. For instance, while a distinct section of code (with defined sets of inputs and outputs) may be identifiable in a first application (e.g., non-optimized code), it might be optimized away entirely in another application (e.g., optimized code). Alternatively, while a first section of code in a first application might have a common sets of inputs and outputs with a second section of code in a second application, the first section of code in the first application might do some work that has been optimized out of the second section of code in the second application and placed into a third section of code in the second application; for example, some work may have been lifted out of a loop. Thus, in order to facilitate clean function mappings between these two applications, a given “function” that is identified as mapping to another application might actually be a collection of a plurality of sections. For instance, in the examples above of a compiler optimizing code away entirely in the second application, or of a compiler moving work from the second chunk of code in the second application to the third chunk of code in the second application, it might actually take combining two (or more) sections in one or both of the applications in order to arrive at common functions between the applications that have mappable sets of inputs and outputs, and that do equivalent work.

In embodiments, when defining a function as a collection of sections, this can be done inclusively, exclusively, or somewhere in-between. For example, suppose that the function identification component 115a can identify three sections—A, B, and C—in a first application, in which section A called section B, and in which section B called section C during the traced execution. In this situation, a single “function” in that first application (and that maps with a second application) might be defined as the sum of the chunks of code in section A, B, and C (i.e., inclusive of everything section A called during the traced execution). Alternatively, a single “function” for mapping with the second application might be defined as the chunk of code in section A only (i.e., exclusive of everything section A called during the traced execution). Alternatively again, a single “function” for mapping with the second application might be defined as the sum of the chunks of code in section A and B, but not section C (i.e., partially inclusive and partially exclusive).

In embodiments, it is possible for the function identification component 115a to define and map functions that include sequences of instructions that have one or more gaps within their execution. For example, a function might include a sequence of instructions that make a kernel call—which might not be recorded—in the middle of their execution. To illustrate, function 402-a1 might take as inputs a file handle and a character, and include instructions that compare each byte of the file with the input character to find occurrences of the character in the file. Because they rely on file data, these instructions might make one or more kernel calls to read the file (e.g., using the handle as a parameter to the kernel call). This function 402-a1 (with its gap(s)) might then be mapped to function 402-b1, which could be an alternate implementation/compilation of those instructions, with their own gap(s). In order to identify/map functions with gaps, the function identification component 115a may need to ensure that these gaps are properly ordered in each of functions 402-a1 and 402-b1 with respect to the comparison operations, so the file data is processed in the same order in each of functions 402-a1 and 402-b1. Since the sets of inputs 403-a and outputs 404-1 of functions 402-a1 and 402-b1 do not change, any differences would be internal to the functions, and these differences (e.g. different local data structures) are eventually deallocated (e.g., stack popping being a deallocation) so the differences don't affect the outputs of the functions. It is noted that, in embodiments, any register values changed by a kernel call are tracked in the recorded execution(s) 113. Nonetheless, the function identification component 115a might additionally, or alternatively, use an ABI and/or debugging symbols to track which registers values are retained across a kernel call. For instance, the stack pointer (i.e., ESP on x86 or R13 on ARM) may be retained across kernel calls.

In embodiments, inputs and outputs are composable. For example, if a single function in an application 112 is inclusively defined as the entirety of the code in section A, B, and C, then this function's set of inputs might be defined as an input set including the combination of each of the inputs of section A, B, and C, and its set of outputs might be defined as an output set including the combination of each of the outputs of section A, B, and C. It will be appreciated that when an input (or output) to section B is allocated by (or de-allocated by) section A, or if it is allocated by section B and de-allocated by section A, then that input (or output) to function B may be omitted from the input set (or output set). It will also be appreciated that any input (or output) of a section called within a broader function (i.e., that includes the section), and which is not an input (or output) of the broader function may be omitted from an input set (or output set) for the broader function, or may otherwise be tracked as internal to the broader function.

Complications might also arise due to function inlining, particularly when a child function is not going to be analyzed by the debugging component 109 (e.g., because it comes from a third-party library). For instance, suppose that a first section (A1) of function A executes prior to calling child function B, and then a second section (A2) of function A executes after function B returns. Here, sections A1 and A2 might be treated as independent functions, themselves, with their own sets of inputs and outputs. If function B takes as inputs any of the outputs of A1, those outputs need to be produced before calling into function B; similarly, if function A2 takes as inputs any of the outputs of function B, then those outputs need to appear after the invocation of function B.

In the context of these definitions, if a given sequence of executable instructions that make up a function are deterministic, they should always produce the same data values in their outputs when given the same data values in their inputs. If this sequence of executable instructions is transformed in a way that is functionally equivalent (e.g., due to compiler optimizations, due variances in compilers, and/or due to source code transformations that fix bugs or improve performance without altering behavior of the function as a whole), they should still produce these same output data values when given these same input data values.

For example, in FIG. 4, functions 402-b1, 402-b5, and 402-b9 in representation 401b of a second application are shown with asterisks, indicating that the executable instructions in these functions have been transformed as compared to their corresponding functions (i.e., 402-a1, 402-a5, and 402-a9) in representation 401a of a first application. In embodiments, these transformations may be the result of the second application being compiled with different compiler flags, or with a different compiler version or compiler type as compared with the first application, that resulted in different executable instructions being generated for functions 402-b1, 402-b5, and 402-b9 than functions 402-a1, 402-a5, and 402-a9. Additionally, or alternatively, in embodiments, these transformations may be the result of the second application being compiled from modified source code that includes fixes or improvements that resulted in different executable instructions being generated for functions 402-b1, 402-b5, and 402-b9 than functions 402-a1, 402-a5, and 402-a9.

Based on the application code accessed by the code access component 114b and based on the recorded execution(s) 113 accessed by the trace access component 114a, the coverage identification component 115b identifies which portion(s) of the accessed code are covered by the accessed recorded execution(s) 113, and which portion(s) are not. In particular, the coverage identification component 115b can identify which code paths in the accessed code have corresponding inputs in the recorded execution(s) 113, and which code paths in accessed code lack corresponding inputs in the recorded execution(s) 113. Stated differently, the coverage identification component 115b can identify which code paths have a prior execution or emulation traced into the recorded execution(s) 113, and which code paths do not. In embodiments, the coverage identification component 115b operates on the code of multiple applications 112, such as on different versions of a given application. Thus, for example, the coverage identification component 115b might use one or more first recorded executions 113 of a first version of an application to identify one or more first code paths in the first version of the application that have (and/or do not have) code execution coverage, and/or might use one or more second recorded executions 113 of a second version of the application to identify one or more second code paths in the second version of the application 112 that have (and/or do not have) code execution coverage.

The coverage identification component 115b can operate in various ways to identify which code paths have execution coverage, and which do not. For instance, the coverage identification component 115b might operate at a function level, using the definition of “function” that was described previously in connection with the function identification component 115a. Thus, the coverage identification component 115b might identify which of the identified function(s) have a prior execution or emulation traced into the accessed recorded execution(s) 113, and which function(s) have not.

Additionally, or alternatively, the coverage identification component 115b might operate at a basic block level. As will be appreciated by one of ordinary skill in the relevant art, and as used herein, a “basic block” is a sequence of instructions that are an execution unit; that is, the sequence has a single input point and a single output point, and all or none of the instructions in the basic block either execute or do not execute (exceptions aside). Thus, the coverage identification component 115b might identify which basic blocks have had a prior execution or emulation traced into the accessed recorded execution(s) 113, and which basic blocks have not. It is noted that, at times, a basic block might correspond to a “function” as used herein, though a function might alternatively comprise a plurality of basic blocks. Thus, identifying coverage at a basic block level can potentially be more granular that identifying coverage at a function level.

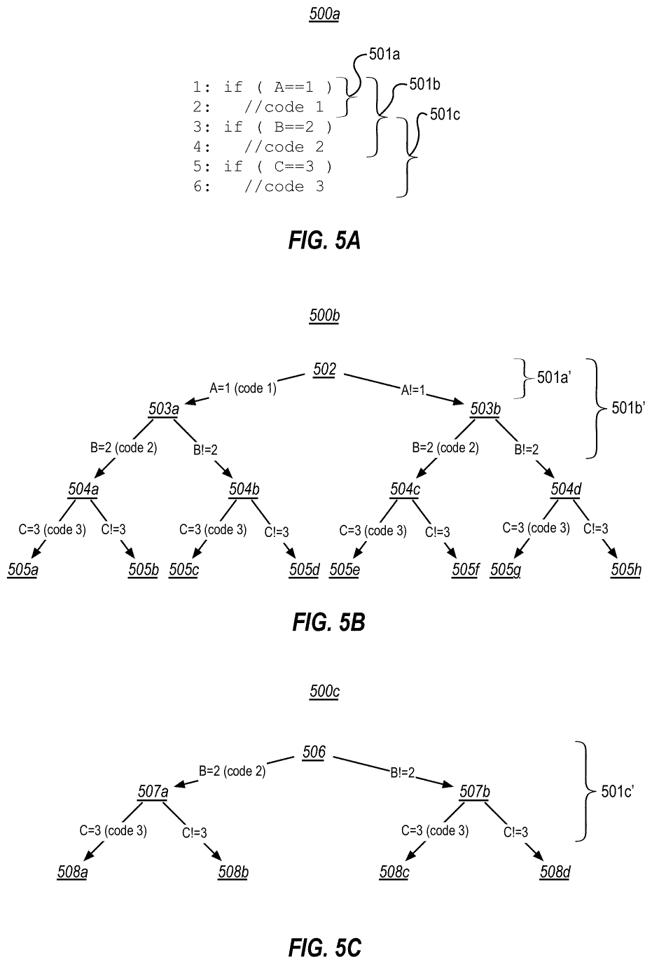

Additionally, or alternatively, the coverage identification component 115b might operate based on control flow analysis. Thus, the coverage identification component 115b might identify which sequences of control flow have been traced into the accessed recorded execution(s) 113, and which sequences of control flow have not. To demonstrate this concept, FIG. 5A illustrates an example 500a that includes a code snippet showing a series of three control statements (i.e., the “if” statements at lines 1, 3, and 5), each of which may have a corresponding block of code (i.e., lines 2, 4, and 6). If the coverage identification component 115b were to operate at a function and/or a basic block level, it might determine there is full coverage if each of these “if” statements was taken at least once during a prior execution or emulation (i.e., code blocks 1, 2, and 3 have each been executed at least once). By doing control flow analysis, however, the coverage identification component 115b might determine coverage based on combinations of execution of these code blocks.

For instance, FIG. 5B illustrates an example 500b that shows possible code execution paths of the control statements in the code snippet of FIG. 5A. As shown in example 500b, a first node 502 corresponding to the first “if” at line 1 could branch to two paths: (i) a first path to node 503a when A=1 and in which the first code block is executed, and (ii) a second path to node 503b when A!=1 and in which the first code block is not executed. Depending on the outcome at node 502, nodes 503a and 503b corresponding to the second “if” at line 3 can branch to four paths: (i) a first path to node 504a when A=1 and B=2 and in which the first and second code blocks are executed, (ii) a second path to node 504b when A=1 and B!=2 and in which only the first code block is executed, (iii) a third path to node 504c when A!=1 and B=2 and in which only the second code block is executed, and (iv) a fourth path to node 504d when A!=1 and B!=2 and in which none of the code blocks are executed. As shown, nodes 504a-504d corresponding to the third if at line 5 can further branch to eight paths to leaf nodes 505a-505h, including all possible combinations of the “if” statements being taken (or not taken), and all possible combination of the code blocks 1, 2 and 3 being executed (or not executed). In embodiments, the coverage identification component 115b might analyze the recorded execution(s) 113 for coverage (or lack thereof) of each these combinations of control flow.

As will be appreciated by one of ordinary skill in the relevant art, analyzing all possible combinations of control flow in an application might be prohibitively expensive in terms of the processing resources and memory required to accomplish the analysis, as well as the time needed to accomplish the analysis, and could result in a prohibitively large number of combinations of control flow to consider as being covered or not covered. Accordingly, in some embodiments, the coverage identification component 115b might “trim” the search space of a control flow analysis. In embodiments, this trimming might be accomplished using a “sliding window” approach, which limits the control flow analysis to a finite number (i.e., n) of control flow statements.

For example, FIGS. 5A-5C illustrate how a sliding window of n=2 control statements might operate. Returning to FIG. 5A, example 500a shows three windows 501a-501c of size n=2 (i.e., each window considers at most two control statements). Because it corresponds to the first control statement encountered, the first window 501a includes only the first “if” statement; the second window 501b includes the first and second “if” statements, while the third window 501c includes the second and third “if” statements.

In FIG. 5B, window 501a′ shows that, when the coverage identification component 115b considers only the first “if” statement, it considers the two paths from node 502 (i.e., A=1 and A!=1). Similarly, window 501b′ shows that, when the coverage identification component 115b considers both the first and second “if” statements, it considers four paths from nodes 503a and 503b (i.e., A=1 and B=2; A=1 and B!=2; A!=1 and B=2; and A!=1 and B!=2).

Due to the sliding windows, however, the coverage identification component 115b might not consider all three “if” statements together. Instead, FIG. 5C illustrates an example 500c that shows possible code execution paths of the second and third control statements in the code snippet of FIG. 5A. In FIG. 5C, window 501c′ shows that, when the coverage identification component 115b considers both the second “if” statement at node 506 and the third “if” statement at nodes 507a and 507b, it considers only four paths from nodes 507a and 507b: (i) a first path to node 508a when B=2 and C=3, (ii) a second path to node 508b when B=2 and C!=3, (iii) a third path to node 508c when B!=2 and C=3, and (iv) a fourth path to node 508d when B!=2 and C!=3. As such, by limiting the number of control statements considered at once, use of the sliding window has limited the number of combinations of control statements the coverage identification component 115b has considered.

As mentioned, some embodiments may use synthetic inputs to more fully exercise execution of one or more application versions, and to determine if these different application versions execute equivalently. For example, these embodiments can identify a code path in one application version that is not exercised in the recorded executions, and apply synthetic inputs generated to exercise that code path to a corresponding code path in a different application version. To facilitate these embodiments, the code path mapping component 115c can identify one or more code path(s) in a first application version that map to one or more other code path(s) in a second application version. Thus, for example, after the coverage identification component 115b identifies one or more code path(s) in a first application version that lacks execution coverage in the recorded execution(s) 113, the code path mapping component 115c can identify one or more corresponding code path(s) in a second application version.

The code path mapping component 115c can use a variety of techniques to identify corresponding code paths. For example, based on use of the function identification component 115a, the code path mapping component 115c might identify one or more functions that are part of a code path in the first application version, and identify one or more corresponding function(s) in the second application version. In another example, the code path mapping component 115c might identify one or more basic blocks that are part of a code path in the first application version, and identify one or more corresponding basic block(s) in the second application version. In another example, the code path mapping component 115c might use code flow analysis to identify which code maps between the first and second application versions. In another example, the code path mapping component 115c might use symbols to identify which code maps between the first and second application versions (e.g., based on function names that are available in the symbols). In another example, the code path mapping component 115c might apply inputs used to reach the identified code path in the first application version to the second application version, in order to reach the corresponding code path in the second application version.

Based on having identified code paths in any accessed code that are not covered in the accessed recorded execution(s) 113, the inputs generation component 115d can generate synthetic inputs that can be used, during code emulation, to exercise these non-covered code paths in the accessed code. For instance, suppose in FIG. 5B that the code paths to nodes 505b, 505d, 505f, and 505h are not covered by the accessed recorded execution(s) 113 (i.e., there was never an instance where C!=3 when tracing this code into the recorded execution(s) 113). In this instance, the inputs generation component 115d might generate an input value of C=1, or sets of inputs values (e.g., {A=1, B=2, C=1}, {A=1, B=0, C=1}, {A=0, B=2, C=1}, and {A=0, B=0, C=1}), which would cause these code paths to be exercised if supplied as inputs during code emulation. In embodiments, the inputs generation component 115d might only generate synthetic inputs to reach a given code block or path that are compatible with all the inputs that came prior.

The emulation component 116 emulates code accessed by the code access component 114b, based on one or more of the recorded executions(s) 113 accessed by the trace access component 114a. For instance, the emulation component 116 might comprise or utilize the emulation component 111 of FIG. 1A to emulate the accessed code. Using the emulation component 116, the debugging component 109 can replay one or more portions of an accessed application 112, based on executing code of the application 112 while steering that code's execution using traced data values from one or more recorded execution(s) 113. Thus, the emulation component 116 is shown as including an emulation steering component 116a, which can supply application code with traced data values, as needed, in order to steer that code's emulation such that it reproduces a traced execution. During this emulation, the emulation component 116 can substitute inputs, and possibly code as well. Thus, the emulation component 116 is shown as including an inputs substitution component 116b, and potentially a code substitution component 116c.

The inputs substitution component 116b can cause inputs generated by the inputs generation component 115d to be utilized to exercise any code paths that were identified by the coverage identification component 115b to lack coverage in the accessed recorded execution(s) 113 and/or to exercise any code paths that were identified by the code path mapping component 115c to correspond to a code path that lacks coverage in the accessed recorded execution(s) 113. In embodiments, this might be accomplished by the emulation steering component 116a using execution state data from one or more of the recorded execution(s) 113 to steer the emulation of code of an accessed application 112 up to a point where there is a subject code block or code path in that application 112 (e.g., for which there is no code execution coverage, or which maps to a code path lacking execution coverage). This point may, for example, correspond to a control flow instruction that leads to a subject code block or code path. At this point, the inputs substitution component 116b can utilize one or more synthetic inputs generated by the inputs generation component 115d in order to cause execution of this code block or code path to be emulated, such as by substituting in inputs from the recorded execution 113 with synthetic inputs that would cause the control flow instruction to be evaluated in a manner that leads to execution of this code block and/or code path (rather than a code block and/or code path that was recorded in the recorded execution 113, for example).

The emulation component 116 is also shown as including an output generation component 116d, which indicates that code emulation will generate one or more resulting output values. For example, emulation of function 402-a1 produces one or more values into outputs 404-1 based on the value(s) the inputs substitution component 116b used for inputs 403-1, while emulation of function 402-b1 produces one or more values into outputs 404-1 based on the value(s) the inputs substitution component 116b used for inputs 403-1. The particular value(s) produced by the output generation component 116d into these outputs 404-1 will depend on the value(s) used for the inputs 403-1. Thus, for example, if the inputs substitution component 116b uses the same input values for inputs 403-1 when emulating each of functions 402-a1 and 402-a2, and if these functions execute equivalently, the output generation component 116d will produce the same output values into outputs 404-1 based on the emulation of each of these functions. If these functions do not execute equivalently, however, the output generation component 116d might produce different output values into outputs 404-1.

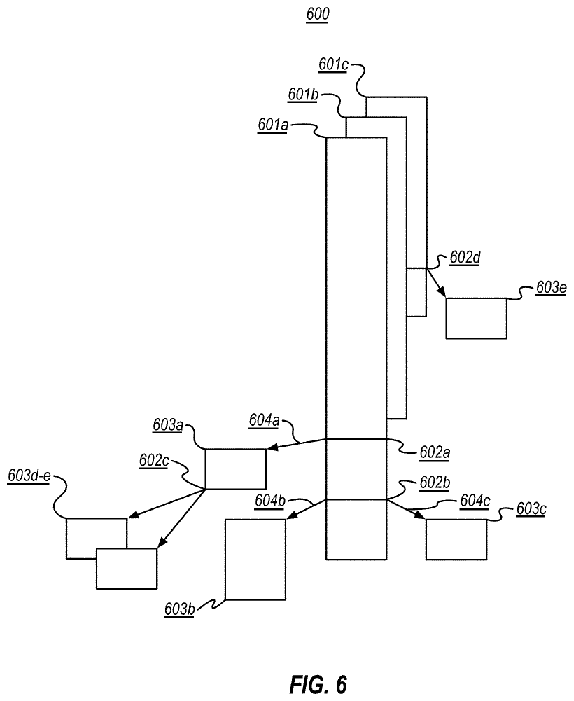

To demonstrate the use of synthetic inputs during emulation, FIG. 6 illustrates an example 600 of substituting synthetic inputs while emulating an executable entity from a recorded prior execution of the entity. In example 600 there are multiple recorded executions 601 (i.e., recorded executions 601a-601c) that were obtained by the trace access component 114a. Each of these accessed recorded executions 601 might provide coverage for one or more portions of code of an application 112 that was accessed by the code access component 114b, whether those be the same code portions or different code portions. Thus, the accessed recorded executions 601 are usable by the coverage identification component 115b to identify code paths of the accessed application 112 for which there is code execution coverage in the accessed recorded executions 601 at least once. In addition, the coverage identification component 115b might identify additional code paths of the accessed application 112 for which there is no coverage in the accessed recorded executions 601.

In order to reach one of these paths for which there is no code execution coverage, the emulation component 116 might emulate execution of the code of application 112 using one or more of recorded executions 601. For instance, the emulation component 116 might use recorded execution 601a emulate execution of portion(s) of the application up to a point 602a in that recorded execution 601a. Point 602a may correspond, for instance, to a control flow statement that could result in two or more different code paths being taken. Since recorded execution 601a continues from point 602a it may record execution of one of these code paths. However, the accessed recorded executions 601 may lack any recorded execution of one or more others of these code paths.

The emulation component 116 can utilize the inputs substitution component 116b to provide synthetic inputs to this control flow statement, which cause one or more of these other code paths to be taken by the emulation component 116 from point 602a. In embodiments, the tracer component 110 can record the emulated execution of these other code path(s). For example, as indicated by an arrow 604a from point 602a, emulation may continue, and be recorded into a new “synthetic” recorded execution 603a, which records an emulated execution of one (or more) of these other code paths, based on the inputs substitution component 116b having provided synthetic inputs to a conditional statement at point 602a.

Notably, the emulation component 116 might use the inputs substitution component 116b to pursue emulation of multiple code paths parallelly and/or serially to achieve greater code execution coverage. FIG. 6 depicts several such examples. For instance, the emulation component 116 might also resume emulation based on recorded execution 601a, starting at point 602a, or starting at some key frame following point 602a. While this might mean emulating a code path for which there is already coverage by recorded execution 601a (e.g., by using recorded inputs), this emulation path might reach another point 602b where there is another control flow statement that could result in two or more different code paths being taken. As shown by arrows 604a and 604b, the emulation component 116 might use synthetic inputs to parallelly (and/or serially) pursue—and the tracer component 110 might record—two different code paths for which there was not already coverage (i.e., synthetic recorded executions 603b and 603c). Returning to synthetic recorded execution 603a, it may also be that the emulation component 116 reaches a control statement at point 602c where there are further code paths that have no coverage. Thus, the emulation component 116 might use synthetic inputs to pursue these code paths (i.e., synthetic recorded executions 604d and 603e). The emulation component 116 might also pursue code paths with no coverage based on others of the accessed recorded executions 601. For example, FIG. 6 shows that the emulation component 116 uses synthetic inputs to pursue a non-covered code path at point 602d in recorded execution 601c, with this code path being traced into synthetic recorded execution 603e.

If multiple versions of application code were accessed by the code access component 114b, the emulation component 116 might additionally do a code substitution with the code substitution component 116c. Thus, the emulation component 116 can provide synthetic inputs to code that is being emulated based on trace data that was gathered during execution of other, related code. For example, an accessed recorded execution 113 might include execution state data relating to a prior execution of function 402-a1 in representation 401a of code of a first application. Typically, to replay this prior execution of the executable instructions of function 402-a1, the emulation component 116 would use recorded data inputs (e.g., the data inputs portion 304 of data packets 302) to provide data values, as needed, to data locations corresponding to the inputs 403-1 that were consumed by the executable instructions of function 402-a1. The emulation component 116 would then emulate these instruction's execution using these data values, in order to produce data values in the data locations corresponding to outputs 404-1. However, rather than using the executable instructions of function 402-a1, the code substitution component 116c can cause the emulation component 116 to use these same recorded data inputs to provide data values, as needed, during emulation of the executable instructions of function 402-b1 in representation 401b of code of a second application. This process can be repeated for any number of functions (e.g., functions 402-b1 to 402-b9). During emulation of one or more of functions 402-b1 to 402-b9 based on the traced inputs to functions 402-a1 to 402-a9, the inputs substitution component 116b might also substitute in synthetic inputs to reach code paths that may not normally be reachable in this second application using the traced inputs.

Notably, the code substitution component 116c might also be able to substitute code without use of synthetic inputs. For example, the trace access component 114a might access a recorded execution 113 of a first version of an application 112. In addition, the code access component 114b might access code of a second version of the application 112. Then, during emulation by the emulation component 116, the emulation steering component 116a might steer code emulation using the recorded execution of the first version of the application 112, while the code substitution component 116c substitutes in code from the second version of the application 112. Thus, code of the second version of the application 112 can be emulated using a recorded execution of the first version of the application 112. In this situation, the emulation analysis component 117 can compare the emulated execution of the second version of the application 112 with the traced execution of the first version of the application 112 in order to determine if they execute equivalently with traced inputs. A more detailed description of these embodiments can be found application co-pending application, U.S. Ser. No. 16/358,221, filed Mar. 19, 2019, and entitled “EMULATING NON-TRACED CODE WITH A RECORDED EXECUTION OF TRACED CODE,” the entire contents of which are incorporated by reference herein in their entirety.

As was mentioned, a function might include gaps, such as a gap caused by call to a non-traced kernel call. In embodiments, the emulation component 116 can use one or more techniques to gracefully deal with these gaps. As a first example, the emulation component 116 might determine from an accessed recorded execution 113 what inputs were supplied to the kernel call, and then emulate the kernel call by the emulation component 116 based on those inputs. As a second example, the emulation component 116 might treat the kernel call as an event that can be ordered among other events in an accessed recorded execution 113, and rather than emulating the kernel call, the emulation component 116 can ensure that any visible changes made by the kernel call (e.g., changed memory values, changed register values, etc.) are exposed as inputs to code that executes after the kernel call. As a third example, the emulation component 116 might set up appropriate environmental context, and then make an actual call to a running kernel using these inputs. As a fourth example, emulation component might simply prompt a user for the results of a kernel call.

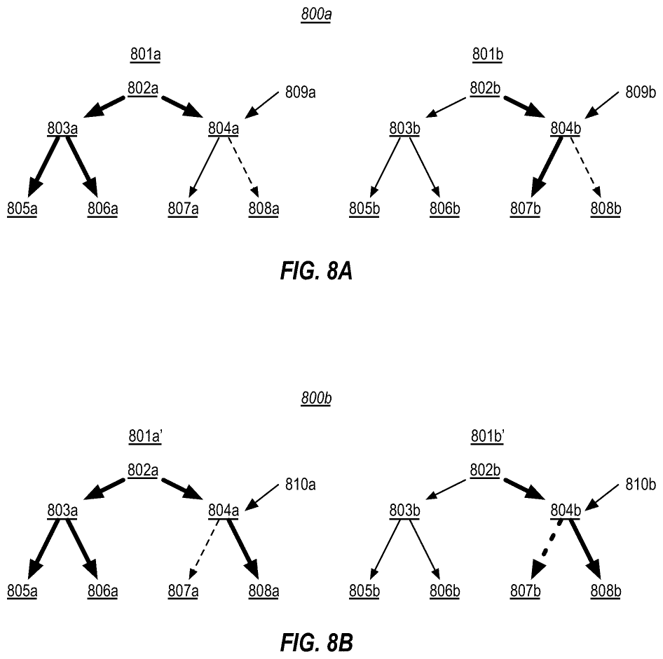

To further demonstrate the use of synthetic inputs during emulation, FIGS. 8A and 8B illustrate examples of using synthetic inputs generated for exercising a code path in one version of an application 112 in order to emulate execution of another version of the application 112. Initially, FIG. 8A includes an example 800a that shows a first representation 801a of code paths of a first version of an application 112, and a second representation 801b of code paths of a second version of the application. These representations include nodes 802-808 at which, for example code flow decisions may be made and/or outputs may be generated, and arrows connecting these nodes that represent code paths. In representations 801a/801b, heavy arrows for a given code path means that execution of the path is recorded in a recorded execution 113 (and therefore has execution coverage), while thin arrows indicate that the path is not recorded (and therefore lacks execution coverage). For example, in representation 801a the code paths between nodes 802a and 803a, nodes 803a and 805a, nodes 803a and 806a, and nodes 802a and 804a are shown as having been recorded, while the remaining code paths are shown as not having been recorded. Similarly, in representation 801b the code paths between nodes 802b and 804b and nodes 804b and 807b are shown as having been recorded, while the remaining code paths are shown as not having been recorded.

Given representations 801a and 801b, the coverage identification component 115b might identify the code path from node 804b to node 808b in representation 801b as not being covered/exercised in the recorded executions 113, and the inputs generation component 115d might therefore generate synthetic inputs for exercising this code path in the second version of the application. Correspondingly, the code path mapping component 115c might identify the code path from node 804a to node 808a in representation 801a as a corresponding code path in the first version of the application. Use of broken arrows indicates the identification of these code paths. The emulation component 116 might exercise both of these code paths using the synthetic inputs that were generated for exercising the code path between nodes 804b and 808b. For example, arrow 809b indicates that the inputs substitution component can substitute these synthetic inputs at node 804b to cause the identified code path to be exercised in the second version of the application, while arrow 809a indicates that the inputs substitution component can also substitute these synthetic inputs at node 804a to cause the identified code path to be exercised in the first version of the application. Emulation of these code paths might be recorded by the tracer 110, and be added to the recorded executions 113. FIG. 8B shows an example 800b that illustrates possible state of representations 801a and 801b after the emulation. Now, in representations 801a′ and 801b′, the code paths between nodes 804a and 808a, and between nodes 804b and 808b, are now shown using heavy arrows (i.e. as being covered/recorded).

While FIG. 8A demonstrated using synthetic inputs that were generated to exercise a code path within representation 801b in order to emulate a code path within representation 801a, it could additionally, or alternatively, work the other way (i.e., from representation 801a to representation 801b). For example, FIG. 8B also shows that the coverage identification component 115b might also identify the code path from node 804a to node 807a in representation 801a′ as not being exercised in the recorded executions 113, and the inputs generation component 115d might generate synthetic inputs for exercising this code path in the first version of the application. Correspondingly, the code path mapping component 115c might identify the code path from node 804b to node 807b in representation 801b′ as a corresponding code path in the second version of the application. Arrow 810a indicates that the synthetic inputs generated for exercising the code path between nodes 804a and 807a can be used to exercise that code path, while arrow 810b indicates that these same synthetic inputs can also be used to exercise the code path between nodes 804b and 807b (even though there is already a record execution of that code path). Again, emulation of these code paths might be recorded by the tracer 110, and be added to the recorded executions 113. Although not shown, this process might be repeated any number of times in order to exercise the remaining non-recorded code paths in representation 801b′.

The emulation analysis component 117 can perform various types of analysis on the emulated execution of the accessed applications 112. As shown, the emulation analysis component 117 can include, for example, an emulation comparison component 117a, a classification component 117b, and/or a checker component 117c.

The emulation comparison component 117a can compare one or more sections of emulated execution. For example, the emulation component 116 might have used the code substitution component 116c to emulate non-traced code using a recorded execution of traced code, thus using the same inputs for the traced and non-traced code. In this situation, the emulation comparison component 117a might compare the outputs of the emulated execution of the non-traced code with the outputs of the recorded execution of the traced code. As will be appreciated in view of the disclosure herein, if the executable instructions of a first function (e.g., 402-b1) are functionally equivalent to the executable instructions of a second function (e.g., 402-a1), then emulation of the executable instructions of the first function (e.g., 402-b1) using the recorded data inputs consumed by the second function (e.g., 402-a1) should produce the same data values in the outputs (e.g., 404-1) that were generated by second function (e.g., 402-a1) if the inputs are identical. The emulation comparison component 117a can compare the outputs generated when emulating the first function (e.g., 402-b1) to the outputs that were generated by the first function (e.g., 402-a1) when using the same inputs to determine whether or not this is the case. If the emulation comparison component 117a determines that the outputs are the same, then the executable instructions of the first function (e.g., 402-b1) appear to be equivalent to the executable instructions of the second function (e.g., 402-a1), at least for these inputs. If the outputs are not the same, then the executable instructions of the first function (e.g., 402-b1) may definitely be determined to not be equivalent to the executable instructions of the second function (e.g., 402-a1). In embodiments, the outputs a function (e.g., 402-a1) might be obtained from recorded execution 113 (e.g., from a data stream in recorded execution 113 that stores the outputs of code execution), or might be obtained by also emulating the executable instructions of the function.

If the emulation component 116 used synthetic inputs generated to exercise a code path in one code version to also emulate a corresponding code path in another code version (e.g., relying on the code path mapping component 115c, and as described in connection with FIGS. 8A and 8B), the emulation comparison component 117a might compare the emulation of corresponding code paths. For example, referring to FIG. 8A, the inputs substitution component may have used the same synthetic inputs at nodes 804a and 804b (even though they were generated for node 804b). Given that they received the same inputs, if the code in the code path between node 804b and node 808a executes equivalently to the code in the code path between node 804b and node 808b, these two code paths should produce the same outputs—even if the code in those code paths is not identical. As such, the emulation comparison component 117a can compare these outputs to determine if the code paths executed equivalently.

It is noted that the emulation comparison component 117a might consider a given value to be an output of a function, code path, etc., even if it was not actually written to by that function, code path, etc. For example, different implementations of a given function might produce the same output value, but one implementation might write that output value while the other may not. For example, suppose part of the function's output is an array of unique integers that is being sorted by the function. One version of a function/code path might sort that array using a bubble sort algorithm, while another version of the function/code path might sort the array using a quick sort algorithm. As will be appreciated by one of skill in the art, these algorithms will produce the same sorted array. However, one algorithm might write to a given array location, while the other may not. Either way, that array location can be treated as an output for both functions/code paths.

If the emulation comparison component 117a determines that different code paths do not execute equivalently (i.e., as not producing the same outputs for the same inputs), some embodiments might determine which of multiple inputs caused the differences in the outputs. For instance, the embodiments could perform a “reverse taint” analysis by analyzing the executable instructions of the code path to identify any direct data continuities between the a given output and a set of one or more inputs.

The classification component 117b can classify the results of any emulation by the emulation component 116. For instance, the classification component 117b can classify sets of inputs (whether they be recorded or synthetic) and their resulting outputs. This might be accomplished, for example, by classifying sets of inputs/outputs corresponding to individual functions. In embodiments, the classification component 117b might classify input/output sets based on various behaviors, such as whether the inputs resulted in exceptions, the patterns of functions called based on the inputs, return values resulting from the inputs, inputs that produced no outputs, outputs that did not consume one or more of the inputs, etc. Classifying sets of inputs and outputs can be used to quickly locate particular behaviors in the recorded executions (e.g., where did the exceptions occur?), and/or changed behaviors when doing code substitution (e.g., when emulating modified code, checking for regressions by determining if particular inputs now produce different outputs than they did in the original code).

The checker component 117c can perform one or more queries on recorded executions 113, whether those recorded executions 113 be generated based on “live” code execution, or whether they be generated as a result of supplying synthetic inputs to traced or non-traced code during emulation. These queries can check for various types of behaviors, such as memory leaks (e.g., by querying for any memory allocations that do not have a corresponding deallocation), on “live” recordings, on recordings based on code substitution, and/or on recordings based on inputs substitution.

The output component 118 can output the results of any code emulation by the emulation component 116 and/or the results of any analysis by the emulation analysis component 117. Thus, the output component 118 can facilitate time-travel debugging of “live” recordings, of recordings based on code substitution, and/or of recordings based on inputs substitution, and can provide any analysis of any of these recordings that is produced by the emulation analysis component 117.

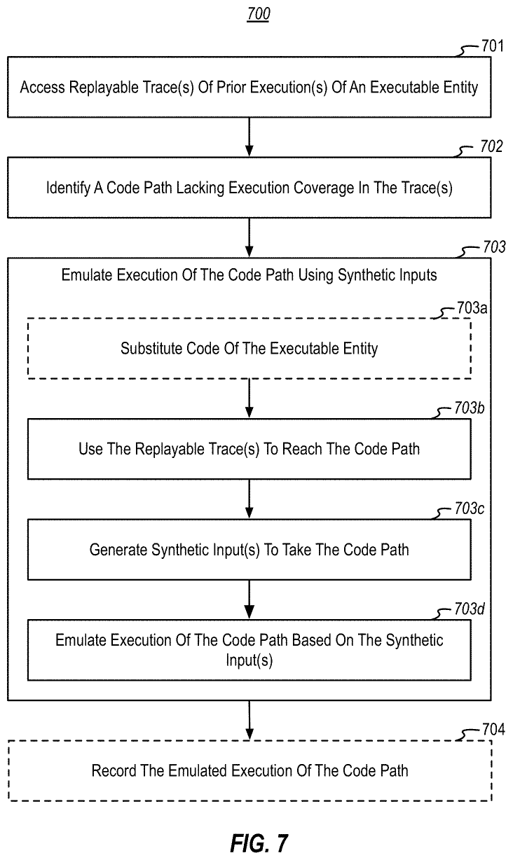

In view of the foregoing, FIG. 7 illustrates a flowchart of an example method 700 for using synthetic inputs during an emulated execution from a recorded execution to reach a code path not recorded in the recorded execution. Method 700 will now be described within the context of FIGS. 1-6. While, for ease in description, the acts of method 700 are shown in a particular order, it will be appreciated that these acts might be implemented in different orders, and/or in parallel.

As shown in FIG. 7, method 700 includes an act 701 of accessing replayable trace(s) of prior execution(s) of an executable entity. In some embodiments, act 701 comprises accessing one or more recorded executions of an executable entity, the one or more recorded executions including recorded inputs that were consumed during one or more prior executions of the executable entity. For example, the data access component 114 can access one or more of recorded executions 113 of an application 112 (e.g., using the trace access component 114a). As shown in FIG. 3, each of these recorded execution(s) 113 might include at least one data stream 301a that includes a plurality of data packets 302; each data packet 302 can include a data inputs portion 304 that records inputs to executable instructions that executed as part of the prior execution of the application. The recorded execution(s) 113 can include prior “live” executions of the application 112 at the processor(s) 102 directly, or through a managed runtime, or prior emulated executions of the application 112 using the emulation component 116. As such, in act 701, the one or more recorded executions 113 could comprise at least one of a “live” execution of the executable entity, or an emulated execution of the executable entity.

Although not expressly shown in FIG. 7, method 700 might also include accessing the code of different versions of the executable entity. For example, the code access component 114b might access code of a first version of an application that is traced into the accessed recorded executions 113, as well as a second version of the application that is not traced into the accessed recorded executions 113.

Method 700 also includes an act 702 of identifying a code path lacking execution coverage in the trace(s). In some embodiments, act 702 comprises, based on the one or more recorded executions, identifying one or more code paths for which there is no recorded execution coverage in the one or more recorded executions. For example, the coverage identification component 115b can identify one or more code paths in an accessed application 112 for which there is no code coverage in the accessed recorded executions 113.

In embodiments, these code paths might be found in the same version of the application that was traced into the recorded executions 113, or another version of the application that is not traced into the recorded executions 113. For instance, if the function identification component 115a is present, and if two versions of application code were accessed by the code access component 114b, the function identification component 115a could identify function mappings between the two versions of the application, and then the coverage identification component 115b could use these mappings to determine which code in the non-traced version of the application would have, and not have, execution coverage based on the recorded executions 113. Thus, in act 702, the one or more recorded executions may record a first version of the executable entity, and identifying the one or more code paths for which there is no recorded execution coverage may comprise identifying the one or more code paths in a second version of the executable entity. Notably, there may be value in comparing inputs and outputs of both versions of the application code, irrespective of how many of those inputs where synthetic, and irrespective of whether there was “uncovered” code on one or both of the versions. The ability to compare against any “baseline” (whether it is based on traced or synthetic inputs) is potentially useful. This means the coverage identification component 115b might look for uncovered paths on either version of the code, or both versions of the code.

As discussed, the coverage identification component 115b can identify code coverage in a variety of manners. For instance, it could use a control flow analysis and/or a block coverage analysis (e.g., using functions or basic blocks). As such, in act 702, identifying the one or more code paths for which there is no recorded execution coverage in the one or more recorded executions might comprise identifying the one or more code paths based on one or more of a control flow coverage analysis or a basic block coverage analysis. If a control flow analysis is used, the control flow coverage analysis may consider combinations of control flow patterns. If so, the control flow coverage analysis might trim a search space based on a sliding window over control flow statements, as described in connection with FIGS. 5A-5C.

Method 700 also includes an act 703 of emulating execution of the code path using synthetic inputs. In some embodiments, act 703 comprises emulating execution of the identified one or more code paths using one or more synthetic inputs. For example, the emulation component 116 can use the inputs substitution component 116b, and potentially also the code substitution component 116c, to emulate the identified code path using synthetic inputs. As shown, act 703 might include several sub-acts.

For example, act 703 might include an act 703a of substituting code of the executable entity. For example, if the accessed recorded execution(s) 113 records a prior execution of a first version of an executable entity (e.g., a first version of application 112), then the code substitution component 116c may substitute in code from a second version of the executable entity (e.g., a second version of application 112) during the emulation. Thus, emulating the prior execution of the executable entity in act 702 may comprise emulating the second version of the executable entity using the accessed recorded execution 113, and acts 703b-703d might operate on the code of this second version of the executable entity.

Act 703 also includes an act 703b of using the replayable trace(s) to reach the code path. In some embodiments, act 703 comprises emulating execution of one or more first executable instructions using the recorded inputs to reach an execution point preceding the one or more code paths. For example, as shown in FIG. 6, the emulation component 116 might use inputs data recorded in an accessed recorded execution 601a to reach a point 602a in the recorded execution 601a, where there is a conditional statement that can lead to the identified code path. This emulated execution of the first executable instructions might be an emulated execution of traced instructions (e.g., of a first version of an application whose execution is traced into the accessed recorded executions 113), or an emulated execution of non-traced instructions (e.g., of a second version of the application whose execution is not traced into the accessed recorded executions 113). Thus, based on act 703a, in act 703b emulating execution of the one or more first executable instructions using the recorded inputs might comprise substituting code of a first version of the executable entity with code of a second version of the executable entity.

Act 703 also includes an act 703c of generating synthetic input(s) to take the code path. In some embodiments, act 703c comprises generating the one or more synthetic inputs, which would cause one or more second executable instructions of the one or more code paths to be executed. For example, the inputs generation component 115d can generate synthetic input(s) that, if used when emulating the conditional statement at point 602a, would cause one or more second executable instructions of the identified code path to be taken. Thus, in act 703c, generating the one or more synthetic inputs could comprise generating one or more synthetic inputs that cause a branch to be taken in order to execute the one or more second executable instructions. Notably, if it is a second, non-traced, version of the executable entity that is being emulated, it may be possible that these second executable instruction(s) are present in the second version of the executable entity, but not the first version of the executable entity.

Act 703 also includes an act 703d of emulating execution of the code path based on the synthetic input(s). In some embodiments, act 703d comprises, based on use of the one or more synthetic inputs, emulating execution of the one or more second executable instructions. For example, the inputs substitution component 116b can cause the conditional statement at point 602a to be evaluated with the synthetic inputs generated in act 703c, causing the identified code path to be taken by the emulation component 116.

Method 700 may also include an act 704 of recording the emulated execution. In some embodiments, act 704 comprises recording the emulated execution of the one or more second executable instructions. For example, the tracer component 110 might record the emulated execution of the second executable instruction(s) into a synthetic recorded execution 603a, and add that recorded execution to the available recorded executions 113, thereby increasing the overall code coverage of the recorded executions 113.

Notably, method 700 might also include performing any types of analysis available to the emulation analysis component 117, such as comparing the outputs of emulating a second version of a function to the outputs of executing a first version of a function (i.e., emulation comparison component 117a), classifying different sets of inputs and outputs (i.e., classification component 117b), and/or running one or more checkers (e.g., queries) against the accessed recorded executions 113 and/or any synthetically-generated recorded executions (i.e., checker component 117c). Thus, for instance, method 700 might include classifying one or more outputs resulting from the emulated execution of the one or more second executable instructions using the one or more synthetic inputs.

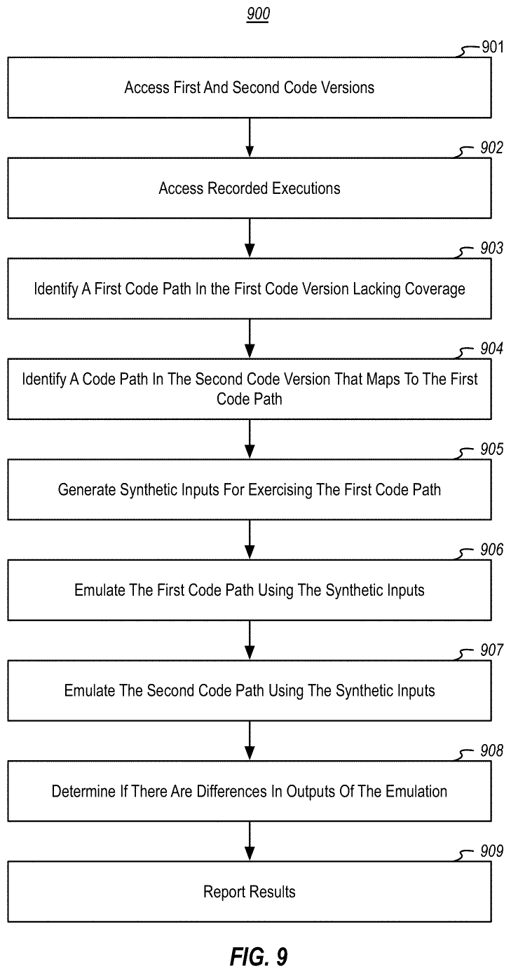

FIG. 9 illustrates a flowchart of an example method 900 for using synthetic inputs to determine if different versions of executable code execute equivalently. Method 900 will now be described within the context of FIGS. 1-8B. While, for ease in description, the acts of method 900 are shown in a particular order, it will be appreciated that these acts might be implemented in different orders, and/or in parallel.

As shown in FIG. 9, method 900 includes an act 901 of accessing first and second code versions. In some embodiments, act 901 comprises accessing a first version of executable code, and accessing a second version of executable code. For example, the code access component 114b might access multiple versions of the code of an application 112. Referring to FIGS. 8A and 8B, for instance, the code access component 114b might access a first version of executable code that corresponds to representation 801a/801a′, and a second version of executable code that corresponds to representation 801b/801b′. This executable code might be accessed from one or more recorded executions 113 and/or from an application binary image. The different application versions might differ due to source code changes, compiler version or compiler product changes, compiler settings changes, etc.

Method 900 also includes an act 902 of accessing recorded executions. In some embodiments, act 902 comprises accessing one or more recorded executions recording one or more prior executions of one or both of the first version of the executable code or the second version of the executable code. For example, the trace access component 114a can access one or more of recorded executions 113. The accessed recorded executions could record one or more runs of the accessed first version of the executable code and/or the accessed second version of the executable code. Thus, the recorded executions 113 might record multiple instances of a given function, code path, etc.

Method 900 also includes an act 903 of identifying a first code path in the first code version lacking coverage. In some embodiments, act 903 comprises, based on the one or more recorded executions, identifying a first code path in the first version of the executable code for which there is no recorded execution coverage in the one or more recorded executions. For example, the coverage identification component 115b might identify the code path in representation 801a/801a′ that is between nodes 804a and 807a as lacking execution coverage in the recorded executions 113.

Method 900 also includes an act 904 of identifying a code path in the second code version that maps to the first code path. In some embodiments, act 904 comprises identifying a second code path in the second version of the executable code that maps to the identified first code path in the first version of the executable code. For example, the code path mapping component 115c might identify the code path in representation 801b/801b′ that is between nodes 804b and 807b as corresponding to the code path between nodes 804a and 807a in representation 801a/801a′ that was identified in act 903.

As discussed, identification of a mapped code path might be accomplished based on identifying corresponding functions in the different code versions. Thus, in act 904, identifying the second code path in the second version of the executable code that maps to the first code path in the first version of the executable code could comprise identifying at least a second function in the second version of the executable code that maps to a first function in the first version of the executable code, and in which the first and second functions have corresponding sets of inputs and outputs. However, this identification could be accomplished in other ways as well, such as by identifying corresponding basic blocks, performing a code flow analysis, etc.

This mapped code path may, or may not, already have execution coverage in the recorded executions 113. For example, in FIG. 8B, the code path between nodes 804b and 807b is shown using a heavy arrow, and thus as already having mapping execution coverage. Thus, in act 904, there may already exist recorded execution coverage for the second code path in the one or more recorded executions.

Method 900 also includes an act 905 of generating synthetic inputs for exercising the first code path. In some embodiments, act 905 comprises generating one or more synthetic inputs for exercising the first code path, the one or more synthetic inputs selected to cause executable instructions of the first code path to be executed. For example, the inputs generation component 115d can generate one or more inputs that could be supplied at node 804a in order to cause the branch towards node 808a to be taken during emulation.

Method 900 also includes an act 906 of emulating the first code path using the synthetic inputs. In some embodiments, act 906 comprises emulating execution of the first code path based on supplying the first code path with the one or more synthetic inputs, and identifying one or more first outputs of the emulation of the first code path. For example, the emulation component 116 can use the inputs substitution component 116a to supply the synthetic inputs at node 804a, thereby resulting in emulation of the code path between nodes 804a and 808a. As represented by the outputs generation component 116d, this emulation can result in generation of one or more outputs from this code path.

Method 900 also includes an act 907 of emulating the second code path using the synthetic inputs. In some embodiments, act 907 comprises emulating execution of the second code path based on supplying the second code path with the one or more synthetic inputs, and identifying one or more second outputs of the emulation of the second code path. For example, the emulation component 116 can also use the inputs substitution component 116a to supply these same synthetic inputs at node 804b in the other code version, thereby resulting in emulation of the code path between nodes 804b and 808b. As represented by the outputs generation component 116d, this emulation can result in generation of one or more outputs from this code path as well.

The debugger may choose to record one, or both, of these emulations. For example, recording these emulations can contribute to the total recorded execution coverage, or provide additional instances of execution coverage. Thus, act 907 might include recording, into the one or more recorded executions, at least one of: (i) the emulation of execution of the first code path based on supplying the first code path with the one or more synthetic inputs, or (ii) the emulation of execution of the second code path based on supplying the second code path with the one or more synthetic inputs.

Method 900 also includes an act 908 of determining if there are differences in outputs of the emulation. In some embodiments, act 908 comprises determining whether there are any differences between the first and second outputs. For example, the emulation comparison component 117a can compare the outputs generated by emulation of the code path between nodes 804a and 808a in representation 801a/801a′ with the outputs generated by emulation of the code path between nodes 804b and 808b in representation 801b/801b′.

In act 908, the emulation comparison component 117a might identify differences between outputs at varying levels of granularity. For example, it might simply determine that a first value of a given output from the emulated first code path are different from a second value of a corresponding output from the emulated second code path. However, it might additionally identify what, in particular, is different between those first and second values. For example, it might identify which bit(s) of is/are different between those values. If the output corresponds to a data structure, it might identify which field(s) within the data structure is/are different, etc. This, in act 908, determining whether there are any differences between the first and second outputs might comprise identifying a partial difference between one of the first outputs and one of the second outputs.

Method 900 also includes an act 909 of reporting results. In some embodiments, act 909 comprises, when there are no differences between the first and second outputs, reporting that the first and second code paths execute equivalently when supplied with the one or more synthetic inputs. For example, the output component 118 could notify another software component that these two code paths execute equivalently (at least with the generated synthetic inputs). Additionally, or alternatively, the output component 118 could generate a user interface notification that these two code paths execute equivalently (at least with the generated synthetic inputs).

In other embodiments, act 909 comprises, when there are one or more differences between the first and second outputs, reporting that the first and second code paths do not execute equivalently when supplied with the one or more synthetic inputs. For example, the output component 118 could notify another software component that these two code paths do not execute equivalently (at least with the generated synthetic inputs). Additionally, or alternatively, the output component 118 could generate a user interface notification that these two code paths do not execute equivalently (at least with the generated synthetic inputs). If, in act 908, the emulation comparison component 117a identified a partial output, the output component 118 might report that partial output.

While method 900 was described in connection with generating synthetic inputs to exercise a code path in a first code version, and applying those inputs to exercise a corresponding code path in a second code version, it can work the other way as well. For example, if the synthetic inputs already discussed are first synthetic inputs, method 900 could also identify a third code path in the second version of the executable code for which there is no recorded execution coverage in the one or more recorded executions. For example, the coverage indentation component 115b might identify the code path between nodes 804b and 808b in representation 801b/801b′. Then, method 900 could identify a fourth code path in the first version of the executable code that maps to the identified third code path in the second version of the executable code. For example, the code path mapping component 115c could identify the code path between nodes 804a and 808a in representation 801a/801a′. Method 900 could also generate one or more second synthetic inputs for exercising the third code path, in which the one or more second synthetic inputs are selected to cause executable instructions of the third code path to be executed. For example, the inputs generation component 115d could generate synthetic inputs to be supplied at node 804b. Method 900 could also emulate execution of the third code path based on supplying the third code path with the one or more second synthetic inputs, identify one or more third outputs of the emulation of the third code path, emulate execution of the fourth code path based on supplying the fourth code path with the one or more second synthetic inputs, identify or more fourth outputs of the emulation of the fourth code path, and determine whether there are any differences between the third and fourth outputs.

In embodiments, if act 908 found differences in outputs, method 900 might also identify a subset of the one or more inputs that caused the first and second code paths to not execute equivalently. For example, method 900 might performing a “reverse taint” analysis to identify a data continuity between at least one output and at least one input.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements.

What is claimed:

1. A method, implemented at a computer system that includes one or more processors and a memory, for using synthetic inputs to determine if different versions of executable code execute equivalently, the method comprising:
accessing a first version of executable code, and accessing a second version of executable code;
accessing one or more recorded executions recording one or more prior executions of one or both of the first version of the executable code or the second version of the executable code;
based on the one or more recorded executions, identifying a first code path in the first version of the executable code for which there is no recorded execution coverage in the one or more recorded executions;
identifying a second code path in the second version of the executable code that maps to the identified first code path in the first version of the executable code;
generating one or more synthetic inputs for exercising the first code path, the one or more synthetic inputs selected to cause executable instructions of the first code path to be executed;
emulating execution of the first code path based on supplying the first code path with the one or more synthetic inputs, and identifying one or more first outputs of the emulation of the first code path;
emulating execution of the second code path based on supplying the second code path with the one or more synthetic inputs, and identifying one or more second outputs of the emulation of the second code path; and
determining whether there are any differences between the first and second outputs, and
when there are no differences between the first and second outputs, reporting that the first and second code paths execute equivalently when supplied with the one or more synthetic inputs; or
when there are one or more differences between the first and second outputs, reporting that the first and second code paths do not execute equivalently when supplied with the one or more synthetic inputs.

2. The method of claim 1, wherein identifying the second code path in the second version of the executable code that maps to the first code path in the first version of the executable code comprises identifying at least a second function in the second version of the executable code that maps to a first function in the first version of the executable code, the first and second functions having corresponding sets of inputs and outputs.

3. The method of claim 1, wherein there exists recorded execution coverage for the second code path in the one or more recorded executions.

4. The method of claim 1, further comprising recording, into the one or more recorded executions, at least one of: (i) the emulation of execution of the first code path based on supplying the first code path with the one or more synthetic inputs, or (ii) the emulation of execution of the second code path based on supplying the second code path with the one or more synthetic inputs.

5. The method of claim 1, wherein the method reports that the first and second code paths do not execute equivalently when supplied with the one or more synthetic inputs.

6. The method of claim 5, further comprising identifying a subset of the one or more inputs that caused the first and second code paths to not execute equivalently.

7. The method of claim 6, wherein identifying the subset of the one or more inputs that caused the first and second code paths to not execute equivalently comprises performing a reverse taint analysis between at least one output and at least one input.

8. The method of claim 1, wherein determining whether there are any differences between the first and second outputs comprises identifying a partial difference between one of the first outputs and one of the second outputs.

9. The method of claim 1, wherein,
identifying the one or more first outputs of the emulation of the first code path comprises identifying an output that corresponds to a memory location that was not written to during the emulation of the first code path; or
identifying the one or more second outputs of the emulation of the second code path comprises identifying an output that corresponds to a memory location that was not written to during the emulation of the second code path.

10. The method of claim 1, wherein the one or more synthetic inputs comprise one or more first synthetic inputs, the method further comprising:
based on the one or more recorded executions, identifying a third code path in the second version of the executable code for which there is no recorded execution coverage in the one or more recorded executions;
identifying a fourth code path in the first version of the executable code that maps to the identified third code path in the second version of the executable code;
generating one or more second synthetic inputs for exercising the third code path, the one or more second synthetic inputs selected to cause executable instructions of the third code path to be executed;
emulating execution of the third code path based on supplying the third code path with the one or more second synthetic inputs, and identifying one or more third outputs of the emulation of the third code path;
emulating execution of the fourth code path based on supplying the fourth code path with the one or more second synthetic inputs, and identifying or more fourth outputs of the emulation of the fourth code path; and
determining whether there are any differences between the third and fourth outputs.

11. A computer system comprising:
at least one processor; and
at least one computer-readable media having stored thereon computer-executable instructions that are executable by the at least one processor to cause the computer system to determine if different versions of executable code execute equivalently, the computer-executable instructions including instructions that are executable by the at least one processor to cause the computer system to perform at least the following:
access a first version of executable code, and access a second version of executable code;
access one or more recorded executions recording one or more prior executions of one or both of the first version of the executable code or the second version of the executable code;
based on the one or more recorded executions, identify a first code path in the first version of the executable code for which there is no recorded execution coverage in the one or more recorded executions;
identify a second code path in the second version of the executable code that maps to the identified first code path in the first version of the executable code;
generate one or more synthetic inputs for exercising the first code path, the one or more synthetic inputs selected to cause executable instructions of the first code path to be executed;
emulate execution of the first code path based on supplying the first code path with the one or more synthetic inputs, and identify one or more first outputs of the emulation of the first code path;
emulate execution of the second code path based on supplying the second code path with the one or more synthetic inputs, and identify one or more second outputs of the emulation of the second code path; and
determine whether there are any differences between the first and second outputs, and
when there are no differences between the first and second outputs, report that the first and second code paths execute equivalently when supplied with the one or more synthetic inputs; or
when there are one or more differences between the first and second outputs, report that the first and second code paths do not execute equivalently when supplied with the one or more synthetic inputs.

12. The computer system of claim 11, wherein identifying the second code path in the second version of the executable code that maps to the first code path in the first version of the executable code comprises identifying at least a second function in the second version of the executable code that maps to a first function in the first version of the executable code, the first and second functions having corresponding sets of inputs and outputs.

13. The computer system of claim 11, wherein there exists recorded execution coverage for the second code path in the one or more recorded executions.

14. The computer system of claim 11, the computer-executable instructions also including instructions that are executable by the at least one processor to cause the computer system to record, into the one or more recorded executions, at least one of: (i) the emulation of execution of the first code path based on supplying the first code path with the one or more synthetic inputs, or (ii) the emulation of execution of the second code path based on supplying the second code path with the one or more synthetic inputs.

15. The computer system of claim 11, wherein the method reports that the first and second code paths do not execute equivalently when supplied with the one or more synthetic inputs.

16. The computer system of claim 15, the computer-executable instructions also including instructions that are executable by the at least one processor to cause the computer system to identify a subset of the one or more inputs that caused the first and second code paths to not execute equivalently.

17. The computer system of claim 16, wherein identifying the subset of the one or more inputs that caused the first and second code paths to not execute equivalently comprises performing a reverse taint analysis between at least one output and at least one input.

18. The computer system of claim 11, wherein determining whether there are any differences between the first and second outputs comprises identifying a partial difference between one of the first outputs and one of the second outputs.

19. The computer system of claim 11, wherein,
identifying the one or more first outputs of the emulation of the first code path comprises identifying an output that corresponds to a memory location that was not written to during the emulation of the first code path; or
identifying the one or more second outputs of the emulation of the second code path comprises identifying an output that corresponds to a memory location that was not written to during the emulation of the second code path.

20. A computer program product comprising at least one hardware storage device having stored thereon computer-executable instructions that are executable by at least one processor to cause a computer system to determine if different versions of executable code execute equivalently, the computer-executable instructions including instructions that are executable by the at least one processor to cause the computer system to perform at least the following:
access a first version of executable code, and access a second version of executable code;
access one or more recorded executions recording one or more prior executions of one or both of the first version of the executable code or the second version of the executable code;
based on the one or more recorded executions, identify a first code path in the first version of the executable code for which there is no recorded execution coverage in the one or more recorded executions;
identify a second code path in the second version of the executable code that maps to the identified first code path in the first version of the executable code;
generate one or more synthetic inputs for exercising the first code path, the one or more synthetic inputs selected to cause executable instructions of the first code path to be executed;
emulate execution of the first code path based on supplying the first code path with the one or more synthetic inputs, and identify one or more first outputs of the emulation of the first code path;
emulate execution of the second code path based on supplying the second code path with the one or more synthetic inputs, and identify one or more second outputs of the emulation of the second code path; and
determine whether there are any differences between the first and second outputs, and
when there are no differences between the first and second outputs, report that the first and second code paths execute equivalently when supplied with the one or more synthetic inputs; or
when there are one or more differences between the first and second outputs, report that the first and second code paths do not execute equivalently when supplied with the one or more synthetic inputs.
